(19) United States
(12) Patent Application Publication
(10) Pub. No.: US 2007/0220293 A1
(43) Pub. Date: Sep. 20, 2007

(54) Systems and methods for managing power consumption in data processors using execution mode selection

(75) Inventor: Satoru Takase, Austin, TX (US)

Correspondence Address: LAW OFFICES OF MARK L. BERRIER, 3811 BEE CAVES ROAD, SUITE 204, AUSTIN, TX, 78746, US

(73) Assignee: Toshiba America Electronic Components

(21) Appl. No.: 11/377,565

(22) Filed: Mar. 16, 2006

(51) Int. Cl. G06F 1/32

(52) U.S. Cl. 713/320

(57) ABSTRACT

Systems and methods for identifying the power usage characteristics of software programs and using the information to determine the manner in which the software programs will be executed, thereby improving the management of power within the device executing the programs. One embodiment comprises a method for selecting execution modes of software programs to improve power consumption associated with execution of the programs. The method includes identifying a plurality of programs to be executed, where the programs may have multiple execution modes. Each program may have multiple program modules, each of which is the program configured to execute in a corresponding execution mode. Each program module has an associated power profile. The program module, hence execution mode, for each program is selected based on the associated power profile, and is then executed according to the selected execution mode.

### BACKGROUND

1. Field of the Invention

The present invention relates generally to electronic devices, and more particularly to systems and methods for managing power consumption in data processors by appropriately scheduling software programs.

2. Related Art

Integrated circuits such as microprocessors are becoming increasingly complex. The circuit components (e.g., transistors, diodes, resistors and the like) that form these devices are, at the same time, becoming increasingly small so that more and more functions may be performed by a particular integrated circuit. As the number of circuit components and functions grows, the amount of power that is typically consumed by these integrated circuits typically also increases. With the increased power consumption of the circuits, the amount of heat generated within the circuits increases as well. This heat may affect the performance of the devices, and may even cause the devices to fail.

As a result of limited power budgets and the dangers presented by the generation of increased amounts of heat in electronic devices, management of power consumption and temperatures within these devices is becoming increasingly important. The devices are often designed with management of power and temperature in mind, and may include various hardware features to help control these conditions. For instance, the devices may include circuits to detect excessive power consumption or high temperatures, and control systems to reduce the speed or number of operations performed by the devices, thereby reducing the power and temperature of the devices.

While much effort has been expended on the designs of devices to reduce power consumption and temperatures in these devices, relatively little effort has been focused on the software that is executed by the devices. For instance, the devices may be constructed with transistors that use reduced power, or they may shut down components that are not in use. When a software program is executed, however, the execution of the program typically proceeds in the same manner, regardless of the prevailing power and temperature conditions (e.g., regardless of whether or not the power used to execute the program exceeds the power budget of the device.)

It would therefore be desirable to provide systems and methods for identifying the power characteristics of software programs (e.g., power requirements as a function of time) and, based upon this information, controlling the manner in which the programs are executed in order to improve the manner in which power is consumed (as well as the manner in which heat is generated in the executing devices.)

### SUMMARY OF THE INVENTION

One or more of the problems outlined above may be solved by the various embodiments of the invention. Broadly speaking, the invention includes systems and methods for identifying the power usage characteristics of software programs and using the information to determine the manner in which the software programs will be executed, thereby improving the management of power within the device executing the programs.

One embodiment comprises a method for selecting execution modes of software programs to improve power consumption associated with execution of the programs. The method includes identifying a plurality of programs to be executed, where the programs may have multiple execution modes. Each execution mode of each program has an associated power profile. The execution mode for each program is selected based on the associated power profile, and is then executed according to the selected execution mode.

In one embodiment, the execution modes may include delayed execution of the program, extended execution of the program (in which instructions of the corresponding software program are executed at a reduced rate,) execution of a reduced number of processor instructions or operations, and so on. In one embodiment, the execution mode for a program is selected by selecting one of multiple program modules, wherein each of the program modules contains a version of the program that executes in a corresponding one of the execution modes. The method may be implemented, for example, in a multiprocessor system having a plurality of processor cores. The execution modes in this embodiment may be selected to fit within a power budget of the multiprocessor. This power budget may be determined by a power management unit based on power information received from the multiprocessor. In one embodiment, the method may include selection and execution of one or more dummy programs to reduce the magnitude of changes in the total current drawn by the processor cores, or to minimize changes in voltage across the integrated circuit chip on which the multiprocessor is constructed.

Another embodiment comprises a system including a data processor and a power management unit. The data processor is configured to concurrently execute multiple software programs. The power management unit is configured to select execution modes for the programs to be executed based on power profiles associated with the execution modes. The power management unit may select execution modes such as a delayed execution mode, an extended execution (reduced execution rate) mode, a reduced-instruction mode, a modified-instruction mode, and so on. The power management unit may select the execution modes by selecting program modules that are configured to be executed according to the execution modes, by setting execution parameters, etc. The data processor may be a multiprocessor having a plurality of processor cores, and the power management unit may select execution modes to fit within a power budget of the multiprocessor. This power budget may be determined by the power management unit based on power information received from the multiprocessor. The power management unit may select dummy programs for execution by the processor cores to reduce the magnitude of changes in the total current drawn by the processor cores, or to minimize changes in voltage across the integrated circuit chip on which the multiprocessor is constructed.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a functional block diagram illustrating the structure of a system in accordance with one embodiment.

FIG. 2 is a diagram illustrating the differences in power consumption between several different versions of a software program.

FIG. 3 is a detailed functional block diagram showing a system in accordance with one embodiment.

FIG. 4 is a flow diagram summarizing operation of the system illustrated in FIG. 3.

FIGS. 5A-5C are diagrams illustrating the power consumption of a multiprocessor corresponding to execution of software programs A-D in both a conventional manner and several inventive manners according to different embodiments.

FIGS. 6A-6C are diagrams illustrating the results of implementing a power management unit using average-power profiles in accordance with one embodiment.

FIGS. 7A and 7B are diagrams illustrating the identification of available portions of a multiprocessor power budget in a system using detailed power profiles in accordance with one embodiment.

FIG. 8 is a diagram of an exemplary multiprocessor system that utilizes dummy programs to minimize drastic changes in power consumption and current in accordance with one embodiment.

FIGS. 9A-9C are diagrams illustrating the effects of executing dummy programs on power consumption in accordance with one embodiment.

FIGS. 10A-10C are diagrams illustrating the effects of executing dummy programs on voltage variations in a multiprocessor in accordance with one embodiment.

While the invention is subject to various modifications and alternative forms, specific embodiments thereof are shown by way of example in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Broadly speaking, the invention includes systems and methods for identifying the power usage characteristics of software programs and using the information to determine the manner in which the software programs will be executed, thereby improving the management of power within the device executing the programs.

In one embodiment, a microprocessor incorporates multiple processor cores and a power management system. The microprocessor has a limited power budget, so the power management system is designed to determine how a set of software programs can be executed by the processor cores to achieve optimal power usage.

In one embodiment, a software program can be executed in several different ways. For example, the program can be executed normally, in a reduced power mode, or in an extended time mode. In the normal mode, the program is executed the same way it would be executed in an ordinary processor—it would begin execution when received, each instruction in the program would be executed in turn, and execution would terminate after execution of the last instruction in the program. In a reduced power-mode, the program might be executed in a way that causes fewer operations to be performed than in the normal mode, thereby reducing the power used by the program. For instance, if the program is designed to process images, the program in the reduced-power mode might process the images at a lower resolution than in the normal mode. Alternatively, in an extended time mode, a program may be executed at a reduced rate (i.e., fewer instructions may be executed per unit of time) in order to reduce the power consumption of the program.

In this embodiment, the power management system of the microprocessor is configured to determine the power budget (the maximum allowable power usage) of the microprocessor, and then select a mode for execution of each software program so that the power usage of the processor cores in executing the programs is within the power budget. For example, if it would exceed a threshold power to begin execution of four programs simultaneously, the power management system could schedule one of the programs to begin execution after a delay (a delayed-execution mode.) Alternatively, the power management system could select a reduced-power mode for one or more of the programs so that the total power consumption of the four programs remains below the threshold power.

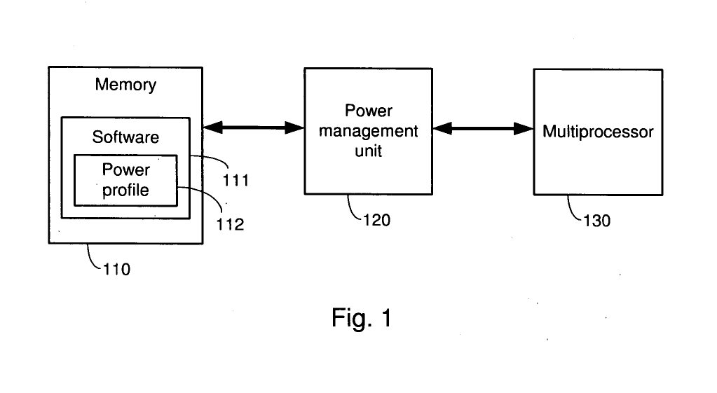

Referring to FIG. 1, a functional block diagram illustrating the structure of a system in accordance with one embodiment is shown. The system of FIG. 1 includes a memory 110, a power management unit 120 and a data processor 130. Software programs stored in memory 110 are provided to, and executed on, data processor 130 under the control of power management unit 120.

Memory 110 stores various different software programs (e.g., 111.) Each of these programs has a power profile (e.g., 112) associated with it. The power profile identifies the power usage characteristics of the corresponding software program. The power profile may have many different forms and many different levels of detail. In some embodiments, for instance, the power profile information may include power usage values as a function of time (or instruction counter.) In other embodiments, the power profile information may include over-threshold information, such as points at which the program causes a processor core to exceed a pre-determined threshold power level, or a simple count of the number of times the program causes the data processor core to exceed the pre-determined threshold power level. The following description will focus primarily on embodiments that utilize power-versus-time data that is easily represented by corresponding graphs. References to power profiles should nevertheless be construed to include any suitable type of power information which is characteristic of the corresponding software program.

It should be noted that memory 110 of FIG. 1 typically stores many software programs. Only one of these programs is explicitly depicted in FIG. 1 for the sake of clarity. It should also be noted that memory 110 stores multiple versions of at least some of the software programs. Each of the versions of a given software program differs from the others in some way. These differences cause the different versions of the program to have different characteristics. In particular, each version of the program has different power usage characteristics. These differences and power usage are accompanied by differences in other characteristics which may include, for example, the rate at which instructions of the program are executed, the number of instructions that are executed, the algorithms that are used in the program, or the like.

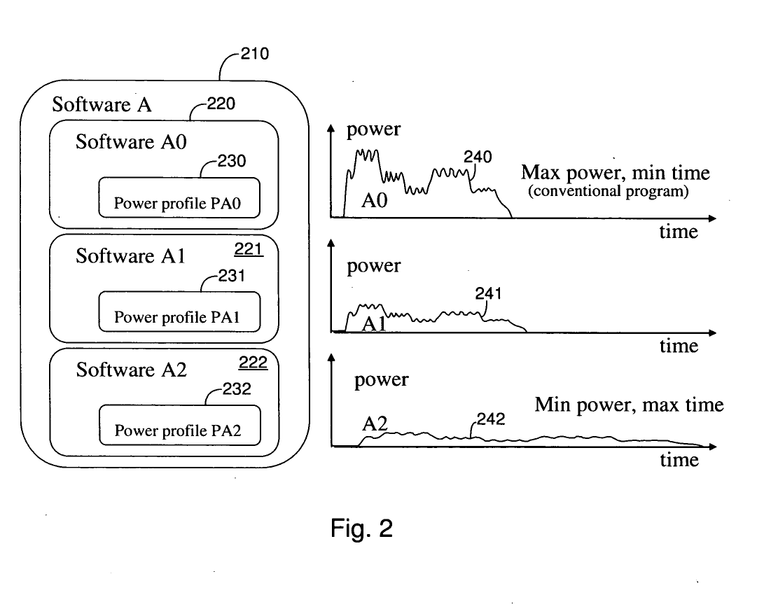

Referring to FIG. 2, a diagram illustrating the differences between several different versions of a software program is shown. On the left side of FIG. 2 is a software program “Software A” (210.) Software A includes three different versions, Software A0 (220,) Software A1 (221,) and Software A2 (222,) of the same program. Each version of the program may be referred to herein as a module. Because each of the modules of Software A is designed to operate differently in order to achieve different power usage characteristics, execution of one of these modules may be referred to herein as executing Software A in a mode corresponding to that module. For example, if module 222 is designed to perform the functions of Software A in a way that extends the execution time of the program in order to reduce peak power consumption, executing this module may be referred to as executing Software A in an extended-execution mode.

Each of the modules of Software A has a corresponding power profile associated with it. As depicted in FIG. 2, power profile 230 is associated with module 220, power profile 231 is associated with module 221, and power profile 232 is associated with module 222. The power profile information is shown graphically on the right side of FIG. 2 so that the differences in the power usage of the different modules can be easily seen.

In the example of FIG. 2, module 220 may be considered a “normal” or “conventional” mode of execution of Software A. in other words, module 220, when executed, is equivalent to execution of Software A in a conventional data processor. The design of the code for this module is typically independent of any specific operating parameters or, more particularly, power usage characteristics. Execution of module 220 is the same as simply executing the unmodified code for Software A when received and continuing until the program terminates. When module 220 is executed in this manner, the amount of power used by the data processor is as shown by the corresponding power curve, 240.

Module 221 of FIG. 2 is modified somewhat from module 220. In this example, the difference is the omission from module 221 of some non-principal part of the code included in module 220. For instance, if Software A is designed to process image data, module 220 may be designed to process the image data at a greater (finer) resolution, while module 221 is designed to process the image data at a lower (more coarse) resolution. The two modules therefore perform the same general function, but module 221 does not have to perform as many operations (because of the lower image resolution) and therefore does not use as much power as module 220. The difference in power usage is represented by power profile curve 241. Execution of module 221 thus proceeds in the same timeframe as execution of module 220, but requires less power.

Module 222 of FIG. 2 is also modified from module 220. In this case, module 222 does not omit any of the instructions that are used in module 220, but instead reduces the rate at which these instructions are executed. While the same amount of energy may be required to execute module 222 as module 220, this energy is distributed over a greater execution time, so the power levels for module 222 (the amount of energy used per unit of time) are less than the power levels for module 220.

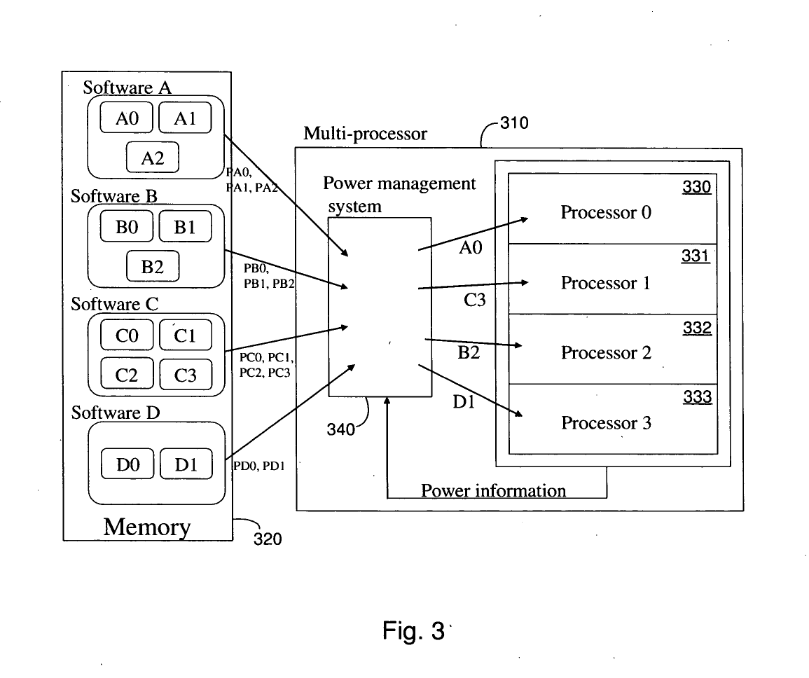

Referring to FIG. 3, a more detailed functional block diagram showing a system in accordance with one embodiment is shown. In this embodiment, the system includes a multiprocessor 310 coupled to a memory 320. Multiprocessor 310 has a set of processor cores 330-333. Each of the processor cores can execute a software program independently of the other processor cores. The programs that are executed by each of processor cores 330-333 are determined by a power management unit 340. When the programs to be executed by processor cores 330-333 are determined by power management unit 340, these programs are retrieved from memory 320 and provided to the processor cores for execution.

Power management unit 340 receives information indicating which software programs are to be executed. For example, if a user commands multiprocessor 310 to execute software programs A, B, C and D, this information is provided to power management unit 340. In this example, each of programs A-D can be executed in several different nodes. Memory 320 therefore stores a program module corresponding to each mode of execution of each program. Software program A has three execution modes, so there are three program modules corresponding to program A stored in memory 320. Similarly, software program B has three execution modes, and memory 320 stores three corresponding program modules. Software programs C and D have four and two execution modes, respectively, so memory 320 stores four and two program modules, respectively, for programs C and D. It should be noted that not all of the software programs that may be executed by multiprocessor 310 need to have multiple execution modes—the multiprocessor may execute a combination of multi-mode and single-mode programs.

Power management unit 340 also receives information identifying the power constraints under which the software programs are to be executed. FIG. 3 includes, for example, an arrow from processor cores 330-333 showing the power information from the processor cores is provided to power management unit 340. This power information may include such things as a threshold power level that should not be exceeded, the power usage of programs that are currently being executed, and the like. Power management unit 340 also receives power information regarding the software programs being executed. In this embodiment, each program module (corresponding to a particular execution mode for a particular program) is stored with power information corresponding to the module. Here, program module A0 is stored with power information PA0, program module A1 is stored with power information PA1, and so on. As described in connection with FIG. 2, the power information may, for instance, consist of a power profile defining the power consumption of the program module as a function of time.

Power management unit 340 selects the execution modes for each of the programs that are to be executed based upon the power information. Power management unit 340 may have various goals in selecting the execution modes, such as keeping the power consumption of the processor cores below the threshold level during execution of the programs, minimizing drastic changes in power consumption during execution of the programs, and so on. As depicted in FIG. 3, power management unit 340, based on the power constraints of the processor cores into the power profiles of the program modules, selects program modules A0, C3, B2 and D1 for execution by processor cores 330-333, respectively.

It should be noted that the system illustrated in FIG. 3 is exemplary, and other embodiments may be implemented in different ways. For instance, while FIG. 3 shows power management unit 340 as a part of the multiprocessor itself, other embodiments may utilize a power management unit that is separate from the multiprocessor. Further, the power management unit may be implemented in hardware, software, or a combination of both.

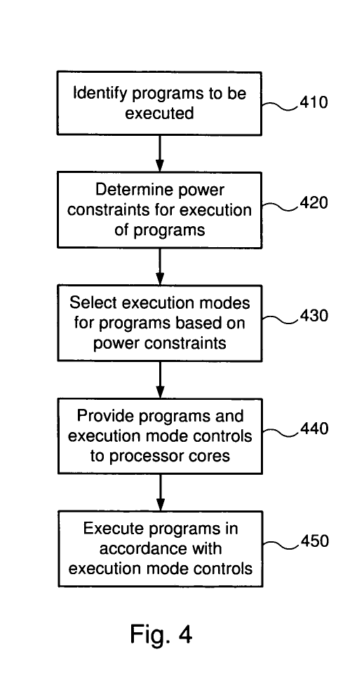

The operation of the system illustrated in FIG. 3 is summarized in the flow diagram of FIG. 4. Referring to FIG. 4, the software programs to be executed are identified (block 410.) At this point, the execution mode of each program is not specified. That is, the specific program module of the software program that will be executed has not yet been selected. The power management and then determines the power constraints that it will try to meet in selecting the execution mode for each of the software programs (block 420.) Determination of the power constraints includes determining both program-independent information (e.g., the maximum power consumption of the multiprocessor) and program dependent information (e.g., the power profiles corresponding to each of the available program modules.)

Once the power constraints have been identified, the power management unit selects an execution mode for each of the software programs (e.g., selects the program module of each software program that will be executed) based upon the identified power constraints (block 430.) When the execution modes for the programs have been determined, the programs (e.g., the selected program modules) are provided to the processor cores (block 440.) That processor cores then execute the programs according to the execution modes selected by the power management unit (block 450.) In the system of FIG. 3, this consists of simply executing the received program modules, which are configured to be executed according to the selected mode.

It should be noted that the execution mode for each program may be selected in various ways. In the exemplary embodiment described above, the execution mode of each program is selected by selecting a program module that executes the program according to a corresponding mode. Alternatively, the execution mode may be selected by setting or defining execution parameters appropriately for the selected mode. The program could then be executed with the defined parameters.

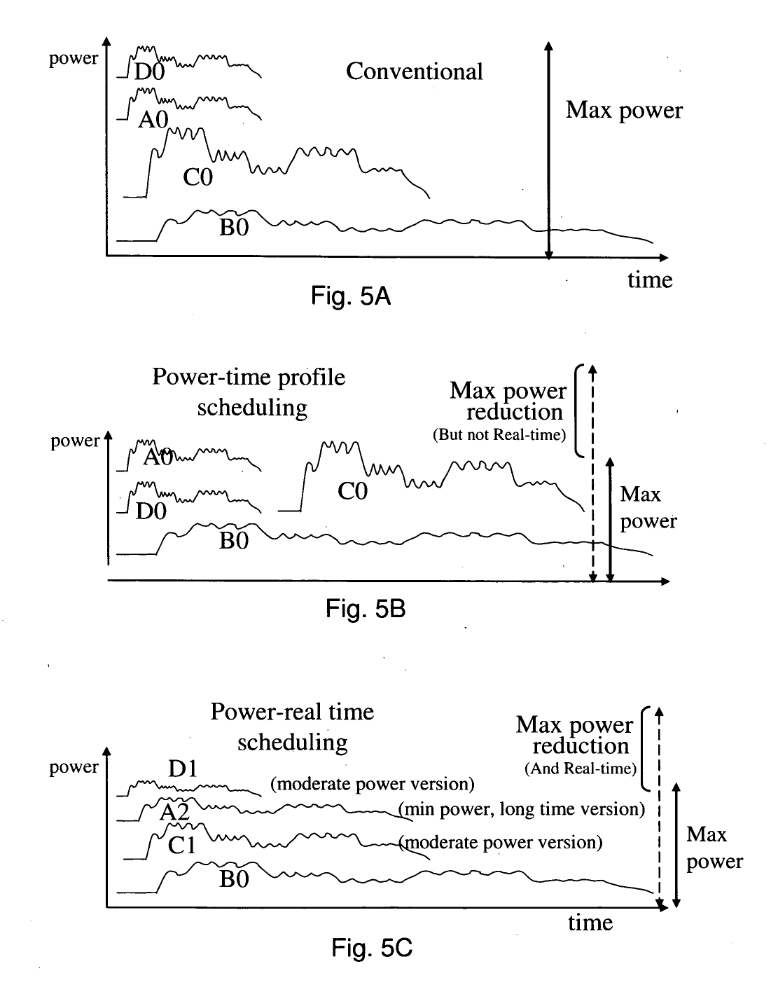

The results of executing the software programs in the manner described above are illustrated in FIGS. 5A-5C. These figures show the power consumption of the processor cores corresponding to execution of software programs A-D in both a conventional manner and the inventive manner described herein. FIG. 5A is a diagram illustrating the power consumption of the processor cores when the programs are executed in the conventional manner. FIGS. 5B and 5C are diagrams illustrating the power consumption of the processor cores when the programs are executed in accordance with exemplary embodiments of the invention.

Referring to FIG. 5A, the power consumption of the processor cores is illustrated for the scenario in which the software programs are executed conventionally. In this scenario, there is only a single execution mode for each program (A0, B0, C0 and D0.) When a program is received by the multiprocessor, the program is immediately executed, regardless of the resulting effects on power consumption. The program is executed in the same manner, no matter when it is received, and no matter what other programs are being executed. Because of four programs are received at the same time, they begin execution of the same time. As a result, the power consumption of the multiprocessor (including the combined power consumption of each processor core) is initially very high, and may exceed a desired power threshold. When execution of programs A0 and D0 terminate, the power consumption drops. The power consumption drops again when program C0 terminates, leaving only program B0 executing. Power consumption in this conventional scenario is not ideal, and the system would benefit from power management to reduce the initial high power consumption and to shift some of this power consumption to the later stages of execution when only a single program is still running.

Referring to FIG. 5B, the power consumption of the processor cores is illustrated for a scenario in which the software programs are executed according to the modes selected by the power management unit. It should be noted that; in this embodiment, the program modules selected by the power management unit for execution have the same power profiles as the programs executed conventionally (see FIG. 5A.) The power management unit, however, delays the start of execution of program module C0 until after execution of program modules A0 and D0 has terminated. For the purposes of this disclosure, the delayed start of program module C0 is referred to as a delayed-execution mode. It can be seen that selection of a delayed-execution mode for program C provides improved overall power consumption by shifting the power consumption associated with program C to the right of the FIGURE (i.e., later in time.) Thus, instead of initially having very high power consumption and then having very low power consumption when only program B is still running (as shown at the right side of FIG. 5A,) the power consumption is more evenly distributed over time, and maximum power is reduced.

It should be noted that many different algorithms may be used for selection of the desired execution modes for the programs, and these algorithms can be readily designed by a person of ordinary skill in the art of the invention. Consequently, the specific algorithms that may be used will not be discussed in detail in this disclosure.

While selecting a delayed-execution mode for a program and thereby shifting the corresponding power consumption in time may be helpful in some situations, there may be other situations in which this is not possible. For example, if all of the programs to be executed have real-time execution constraints, it may not be possible to delay execution of any of the programs. It would be preferable to select other modes of execution that improve the overall power consumption without violating the real-time constraints of the programs. An exemplary scenario is shown in FIG. 5C.

Referring to FIG. 5C, a scenario involving selection of non-delay execution modes for the programs is illustrated. In this scenario, the power management unit selects program modules A2, B0, C1 and D1 for execution by the processor cores. B0 represents the normal (conventional) execution mode for program B. Execution of program module B0 proceeds in the same manner as shown in FIGS. 5A and 5B. Program modules C1 and D1 represent reduced-power execution modes for programs C and D, respectively. As noted above, these program modules may be modified from the normal execution modules to use different algorithms, perform fewer operations, or use other means to reduce the amount of power consumed in the execution of the program modules. It can be seen in the figure that the power consumption for each of these program modules is less than the power consumption of the corresponding conventional execution mode (see FIG. 5A.) Program module A2 represents an execution mode of program A that also reduces the amount of power consumed in executing the program, but does so in the way that extends the amount of time required to complete execution of the program. For example, the instructions of the program module may be performed at a reduced rate in comparison to the normal execution mode. This might be achieved, for instance, by inserting null operations (NOP's) between instructions to effectively delay execution of each successive instruction.

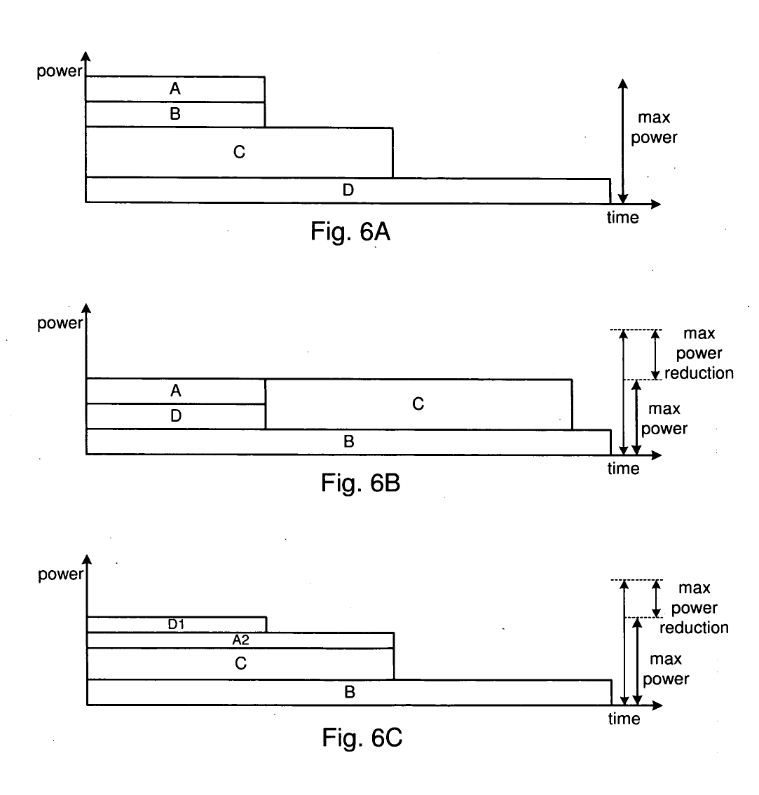

It should be noted that, as pointed out above, the type of power profile information which is used may vary from one embodiment to another. While the examples of FIGS. 5A-5C show power profiles that are relatively detailed, an alternative embodiment may make use of power profiles that are simpler, such as average power during the course of execution of the program module. FIGS. 6A-6C show the results of implementing a power management unit as described above in connection with average-power profiles. Referring to FIG. 6A, conventional execution of programs A-D is again characterized by high power consumption when the programs began execution, dropping to a moderate level after termination of programs A and D, and then dropping to a very low level after termination of program C. Referring to FIG. 6B, a delayed-execution mode is selected for program C, while programs A, B and D are executed in normal modes. As a result, power consumption drops to a moderate level throughout execution of the programs. Referring to FIG. 6C, program A is executed in an extended-time mode, program B is executed in a normal mode, and programs C and D are executed in reduced-operation modes. Again, the result is improved distribution of power consumption through the duration of the programs' execution, and maximum power reduction.

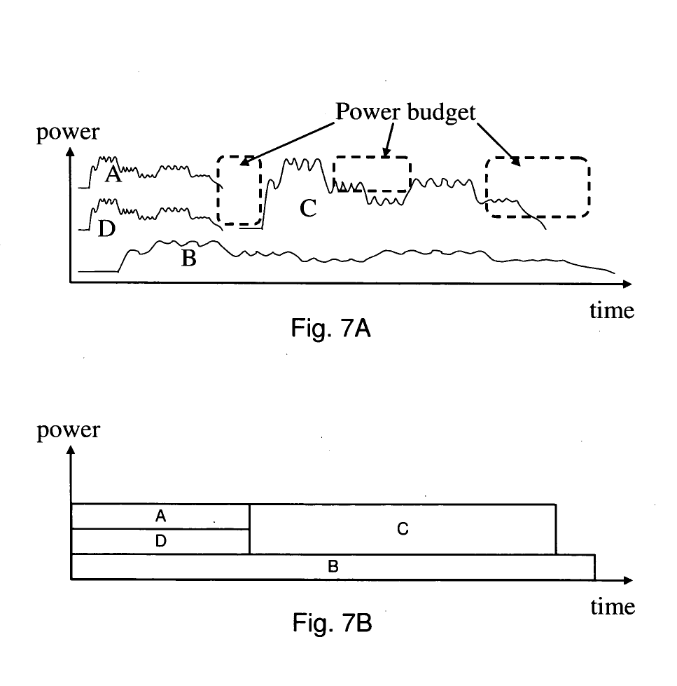

While different embodiments may utilize more or less detailed power profile information, it should be noted that the use of detailed power profile information may allow the power management unit to more effectively select execution modes or schedule program modules. This is because available portions of the power budget corresponding to changes in power consumption within a program may be identified when using the detailed information (see FIG. 7A.) The use of less detailed information, such as average power, may make it impossible to identify these portions of the power budget (see FIG. 7B.)

Another problem that may be addressed by embodiments of the present invention relates to sudden changes in the power consumption of the processor cores. If the power consumption of the multiprocessor is very low (e.g. if most of the processor cores are idle,) and the remaining processor cores begin executing programs at the same time, the power consumption suddenly increases. The increase in power corresponds to an increase in the electrical current (I) to the processor cores (a large dI/dt.) This rapid change in current can cause power noise of the multiprocessor, possibly resulting in malfunctions (e.g., timing errors due to noise.) The same is true of rapid decreases in power and current. It is therefore desirable to avoid the situations.

In some instances, the power management unit may not be able to schedule execution of the program modules so that rapid increases or decreases in power and current are avoided. For instance, real-time constraints may demand that all programs begin executing at the same time. Therefore, one embodiment makes use of a “dummy” program to allow power consumption and current to change more slowly. In this embodiment, the dummy program is scheduled on one or more of the processor cores so that the power consumption of the multiprocessor is ramped up or down, rather than changing drastically.

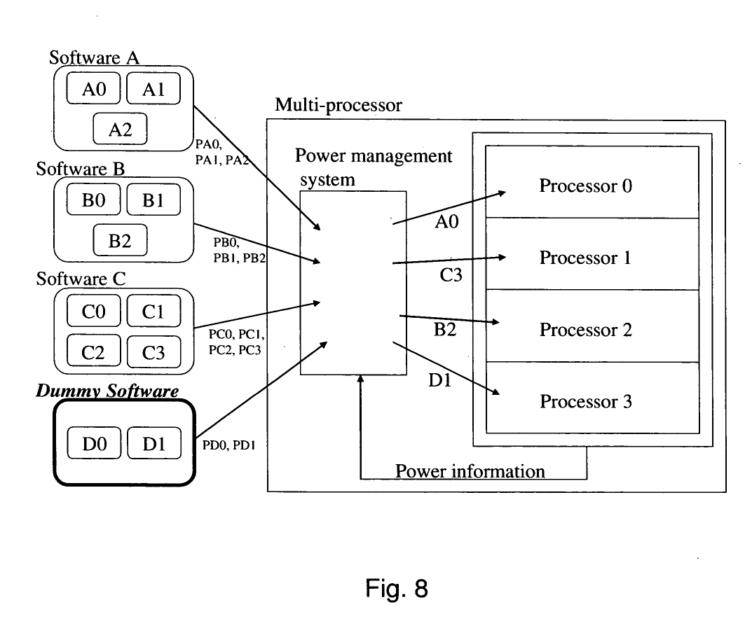

Referring to FIG. 8, an exemplary embodiment that utilizes dummy programs to minimize drastic changes in power consumption and current is shown. This system is very similar to the embodiment illustrated in FIG. 3, except that program D is not an application that is intended to generate any useful data. Instead, this program (and its various modules) is intended to “exercise” one or more of the processor cores, thereby increasing the power consumption and current by some incremental amount. The amount by which the power and current are increased varies with the particular module that is selected. The modules may have different execution times and different power profiles. The power management unit selects one of these modules to be executed by the processor core(s) as needed to ramp up or ramp down the power consumption and current. The modules of dummy program D may be stored in the same memory as the useful programs (A-C,) or it may be stored in a separate memory, such as a memory closely coupled to (e.g., internal to) the power management unit.

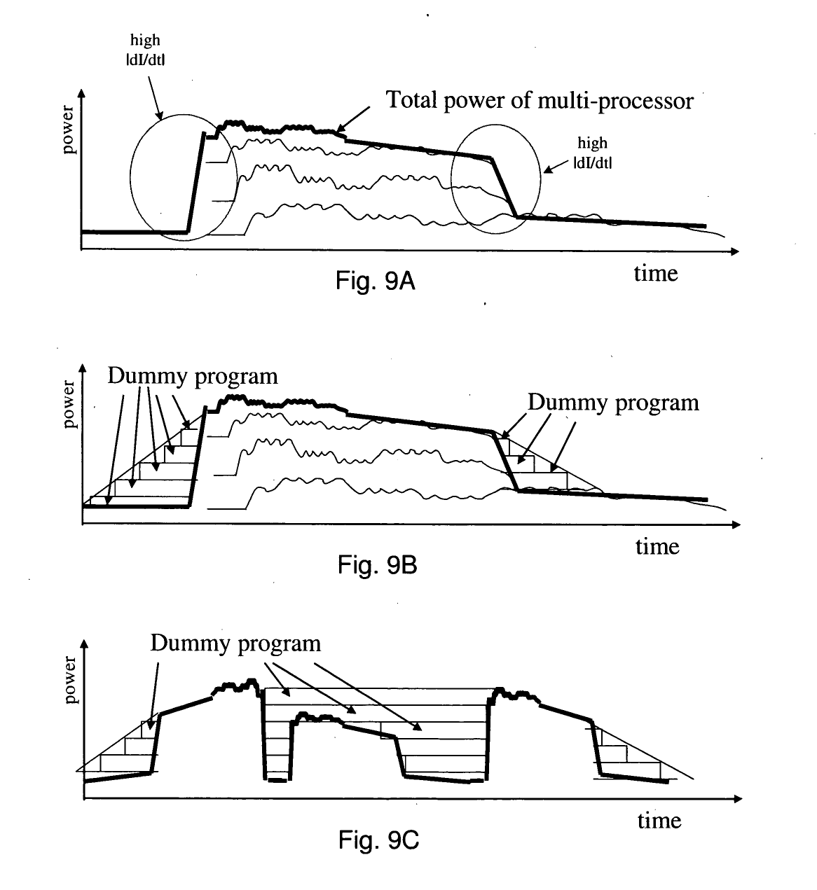

The effect of this embodiment is illustrated in FIGS. 9A-9C. Referring to FIG. 9A, a scenario is illustrated in which a set of useful programs begin executing at about the same time. It can be seen that the current and power consumption increase drastically upon execution of the programs. Even though power consumption during execution of the programs remains relatively steady, the power and current drop drastically upon termination of several of the programs. These rapid increases and decreases in power consumption and current are, as mentioned above, problematic. Referring to FIG. 9B. The power management unit schedules dummy program modules prior to beginning execution of the useful program modules and thereby ramps up the power consumption and current. Execution of the dummy modules terminates as execution of the useful program modules begins. Then, as execution of the useful program modules terminates, execution of dummy program modules begins, allowing the power consumption and current to be ramped down. FIG. 9C illustrates a scenario in which dummy program modules are executed to maintain power consumption and current at a relatively steady level, rather than ramping them up and down. The power management unit thereby avoids the drastic increases and decreases in power consumption and current which can cause problems in the multiprocessor.

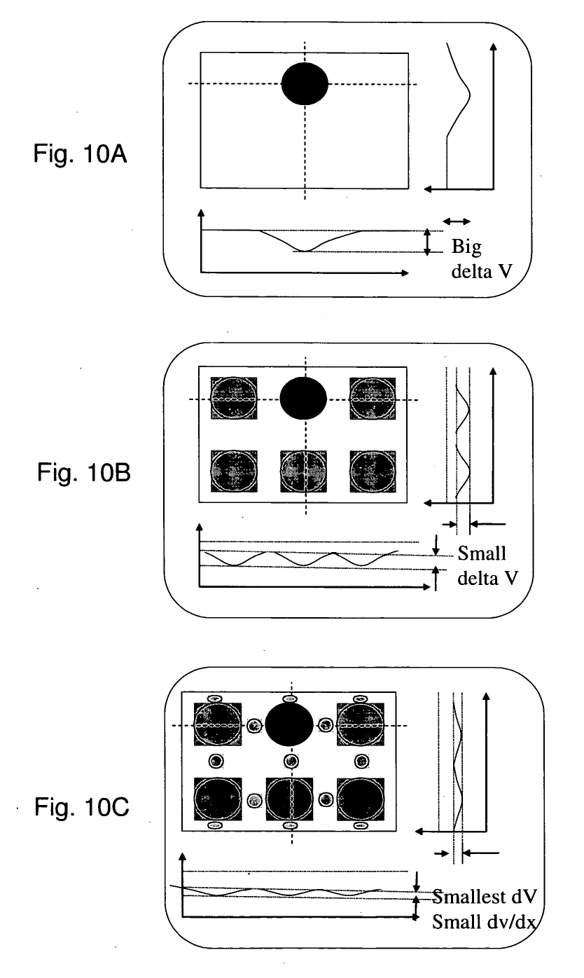

It should be noted that the power management unit may be configured to select the execution modes (e.g., program modules) for execution by the processor cores in a manner which further improves the operation of the multiprocessor. Referring to FIGS. 10A-10C, a set up diagrams illustrating voltage changes across the area of a multiprocessor chip are shown. FIG. 10A illustrates a scenario in which a single processor core is operating, causing a large change in voltage in the vicinity of the processor core. The rectangle represents the multiprocessor chip and the darkened circle indicates the area of the processor core. The graphs below and to the right of the rectangle show changes in voltage across the multiprocessor chip. Because the processor core is the only one operating, the voltage changes large.

In one embodiment of the invention, the power management unit schedules dummy program modules on the other processor cores in order to increase the corresponding power consumption and thereby decrease the voltage differences across the multiprocessor chip. Referring to FIG. 10B, the processor cores executing the dummy program modules are shown in circles with horizontal lines. The graphs below and to the right of the rectangle representing the multiprocessor chip show the reduced variations in voltage across the chip. Referring to FIG. 10C, a scenario is shown in which the power management unit not only selects dummy program modules to be executed on the otherwise idle processor cores, but also selects the dummy program modules such that specific areas of the processor cores are exercised. In this figure, the small circles with the horizontal lines indicate portions of the processor cores (or other circuitry within the multiprocessor) that are exercised by execution of program modules that involve these areas. As shown by the graphs below and to the right of the rectangle representing the multiprocessor chip, the voltage variations across the chip are thereby reduced even further.

As noted above, there may be many variations in the different embodiments of the invention. A few of these variations are described above. For instance: the power management unit can be implemented in hardware or software, and it can be constructed on the multiprocessor chip, or apart from the chip; the execution modes can be selected by choosing program modules configured to operate in the selected modes, or the modes can be selected by setting appropriate execution parameters for the programs; the particular execution modes that are available to be selected may include delayed execution, reduced-power (reduced operation) execution, reduced-rate execution, or other execution modes; different types of power profile information may be associated with the programs in different embodiments; the algorithm used to select the execution modes of the programs may vary from one embodiment to another; and so on. Many other variations will also be apparent to persons of skill in the art of the invention upon reading this disclosure. All of these variations are contemplated to be within the scope of the invention as recited in the claims below.

Those of skill in the art will understand that information and signals may be represented using any of a variety of different technologies and techniques. For example, data, instructions, commands, information, signals, and the like that may be referenced throughout the above description may be represented by voltages, currents, electromagnetic waves, magnetic fields, or any combination thereof. The information and signals may be communicated between components of the disclosed systems using any suitable transport media, including wires, metallic traces, vias, optical fibers, and the like.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A processor may also be implemented as a combination of computing devices, e.g., a combination of a DSP and a microprocessor, a plurality of microprocessors, one or more microprocessors in conjunction with a DSP core, one or more processor cores in a single multiprocessing unit, or any other such configuration.

The steps of a method or algorithm described in connection with the embodiments disclosed herein may be embodied directly in hardware, in software (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. Such a storage medium containing program instructions that embody one of the present methods is itself an alternative embodiment of the invention. One exemplary storage medium may be coupled to a processor, such that the processor can read information from, and write information to, the storage medium. In the alternative, the storage medium may be integral to the processor.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A method comprising:
identifying a plurality of software programs to be executed, wherein one or more of the software programs have multiple execution modes, and wherein each execution mode of each software program has an associated power profile;
for each of the software programs that has multiple execution modes, selecting one of the execution modes based on the associated power profile; and
executing the software programs according to the selected execution modes.

2. The method of claim 1, wherein for one or more of the software programs, the execution modes include a delayed execution mode.

3. The method of claim 1, wherein for one or more of the software programs, the execution modes include an extended execution mode in which instructions of the corresponding software program are executed at a reduced rate.

4. The method of claim 1, wherein for one or more of the software programs, the execution modes include a reduced-operation mode in which the corresponding software program is modified to include a reduced number of processor operations.

5. The method of claim 1, wherein selecting the execution mode for a first one of the software programs comprises selecting one of a plurality of program modules, wherein each of the program modules contains a version of the first one of the software programs that executes in a corresponding one of the associated execution modes.

6. The method of claim 1, wherein the method is implemented in a multiprocessor system having a plurality of processor cores and wherein selecting the execution modes for the software programs comprises selecting execution modes which have associated power profiles that fit within a power budget of the multiprocessor system.

7. The method of claim 6, further comprising identifying the power budget based on power information received from the multiprocessor system.

8. The method of claim 6, further comprising selecting one or more dummy programs for execution by the processor cores, wherein the execution modes of the dummy programs are selected to reduce the magnitude of changes in the total current drawn by the processor cores.

9. The method of claim 6, further comprising selecting one or more dummy programs for execution by the processor cores, wherein the execution modes of the dummy programs are selected to minimizes changes in voltage across an integrated circuit chip on which the multiprocessor system is constructed.

10. A system comprising:
a data processor configured to concurrently execute a plurality of software programs; and
a power management unit coupled to the data processor;
wherein one or more of the software programs have multiple execution modes, and wherein each execution mode of each software program has an associated power profile;
wherein the power management unit is configured to select one of the execution modes for each of the one or more of the software programs based on the associated power profiles; and
wherein the data processor is configured to execute the plurality of software programs using the execution modes selected by the power management unit.

11. The system of claim 10, wherein for one or more of the software programs, the execution modes include a delayed execution mode.

12. The system of claim 10, wherein for one or more of the software programs, the execution modes include an extended execution mode in which instructions of the corresponding software program are executed at a reduced rate.

13. The system of claim 10, wherein for one or more of the software programs, the execution modes include a reduced-operation mode in which the corresponding software program is modified to include a reduced number of processor operations.

14. The system of claim 10, wherein the power management unit is configured to select the execution mode for a first one of the software programs by selecting one of a plurality of program modules, wherein each of the program modules contains a version of the first one of the software programs that executes in a corresponding one of the associated execution modes.

15. The system of claim 10, wherein the system data processor a multiprocessor system having a plurality of processor cores and configured to select the execution modes for the software programs by selecting execution modes which have associated power profiles that fit within a power budget of the multiprocessor system.

16. The system of claim 15, wherein the power management unit is configured to identify the power budget based on power information received from the multiprocessor system.

17. The system of claim 15, wherein the power management unit is configured to select one or more dummy programs for execution by the processor cores to thereby reduce the magnitude of changes in the total current drawn by the processor cores.

18. The system of claim 15, wherein the power management unit is configured to select one or more dummy programs for execution by the processor cores to thereby minimize changes in voltage across an integrated circuit chip on which the multiprocessor system is constructed.

19. The system of claim 10, wherein the power management unit comprises a hardware component of the multiprocessor system.

20. The system of claim 10, wherein the power management unit comprises software executed by the multiprocessor system.
